(19) United States
(12) Patent Application Publication
(10) Pub. No.: US 2014/0181582 A1
(43) Pub. Date: Jun. 26, 2014

(54) AUTOMATIC RETRY FOR POSITION IDENTIFIERS

(71) Applicant: UNISYS CORPORATION, Blue Bell, PA (US)

(72) Inventor: Edward Kujawa, Roseville, MN (US)

(73) Assignee: Unisys Corporation, Blue Bell, PA (US)

(21) Appl. No.: 13/723,750

(22) Filed: Dec. 21, 2012

(51) Int. Cl. G06F 11/14

(52) U.S. Cl. CPC G06F 11/1443
USPC 714/16

(57) ABSTRACT

Applications performance for applications that access connections may be improved by providing a method of automatically retrying failed connections. A method for executing a communication interface may include receiving a retry timer length, receiving an indication that an application group is executing, opening position identifiers for the application group, failing to open at least one position identifier, and automatically retrying opening the position identifier after the retry timer length.

### FIELD OF THE DISCLOSURE

The instant disclosure relates to computer networks. More specifically, this disclosure relates to communications in computer networks.

### BACKGROUND

When a communications interface initializes or is notified an application group is executing, the communications interface may attempt to open all connections designated as automatic open for an application in the application group. If an attempt to open a connection fails, that connection is not tried again. The failure may be caused by network errors, the peer network device being unavailable, or other problems that prevent communication between the communications interface and the destination device. The failure leaves those connections unusable until a system administrator intervenes and solves the problem. One prior solution is to cause the communications interface to make another attempt to open the connection by restarting the application or the operating system hosting the communications interface.

FIG. 1 is a conventional method of establishing connections through a communications interface to network devices. A method 100 begins at block 102 with starting a communications interface, which may happen at start-up of the operating system. At block 104, the communications interface may receive notification of a start-up of an application group. At block 106, connections configured as automatic open connections for the application group are initialized. At block 108, it is determined if any of the connections failed. If not, then the application group executes normally at block 110. If a connection did fail, then the application group is restarted at block 112 and all automatic open connections are then retried. This solution delays operation of the application attempting to execute, and ultimately reduces the ability of the application to complete tasks for the user.

### SUMMARY

An automatic retry of the connection may be attempted after a predetermined delay time. If the problem causing the failure to open the connection is temporary, then additional open attempts may succeed without system administrator intervention. The length of time between retries may be, for example, in the range of 30 to 3600 seconds. This can be easily changed if that is requested. The automatic attempts to reopen the connection may increase the reliability and maintainability of the computer system with the communications interface.

According to one embodiment, a method may include receiving a retry timer length. The method may also include receiving an indication that an application group is executing. The method may further include opening position identifiers for the application group. The method may also include failing to open at least one position identifier. The method may further include retrying opening the position identifier after the retry timer length.

According to another embodiment, a computer program product may include a non-transitory computer readable medium having code to receive a retry timer length. The medium may also include code to receive an indication that an application group is executing. The medium may further include code to open network connections, or position identifiers, for the application group. The medium may also include code to retrying opening a failed position identifier after the retry timer length when at least one position identifier fails to open.

According to yet another embodiment, an apparatus includes a memory, a network adapter, and a processor coupled to the memory and coupled to the network adapter. The processor may be configured to receive a retry timer length. The processor may also be configured to receive an indication that an application group is executing. The processor may further be configured to open, through the network adapter, network connections, or position identifiers, for the application group. The processor may also be configured to retrying opening a failed position identifier after the retry timer length when at least one position identifier fails to open.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the disclosed system and methods, reference is now made to the following descriptions taken in conjunction with the accompanying drawings.

FIG. 1 is a conventional method of establishing connections through a communications interface to network devices.

FIG. 2 is a flow chart illustrating an exemplary method of establishing connections through a communications interface to network devices according to one embodiment of the disclosure.

FIG. 3 is a flow chart illustrating an exemplary method of establishing connections by retrying connections according to one embodiment of the disclosure.

FIG. 4 is a block diagram illustrating a communications interface servicing a number of applications according to one embodiment of the disclosure.

FIG. 5 is a block diagram illustrating a computer network according to one embodiment of the disclosure.

FIG. 6 is a block diagram illustrating a computer system according to one embodiment of the disclosure.

FIG. 7A is a block diagram illustrating a server hosting an emulated software environment for virtualization according to one embodiment of the disclosure.

FIG. 7B is a block diagram illustrating a server hosting an emulated hardware environment according to one embodiment of the disclosure.

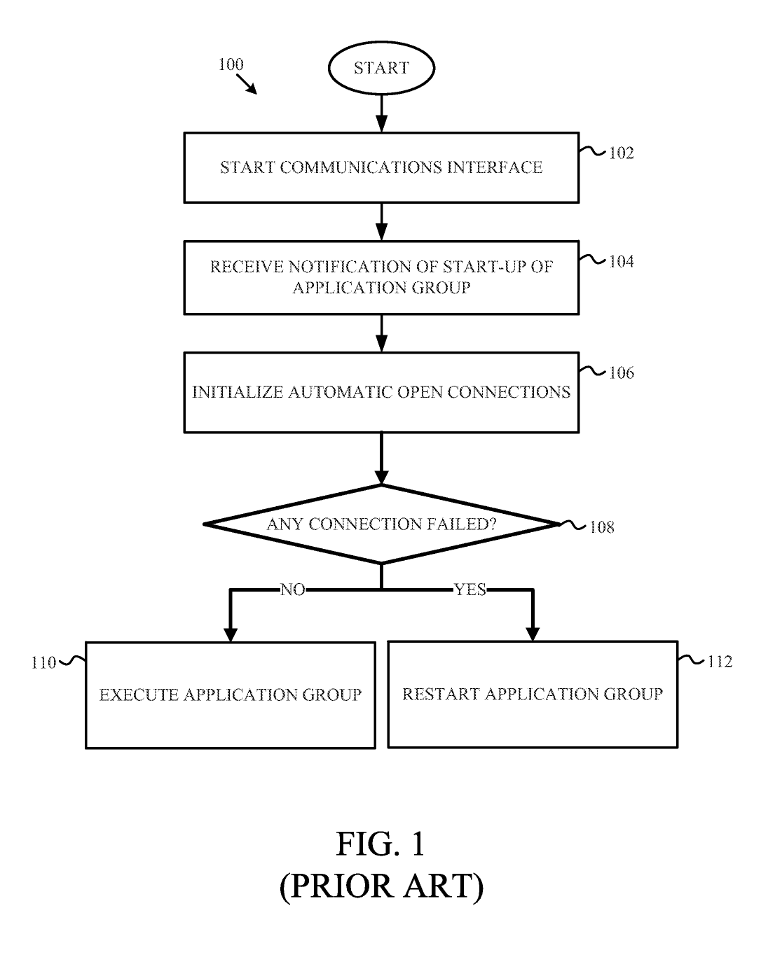

### DETAILED DESCRIPTION

A communications interface, such as a communications interface for transaction applications (CITA), may provide an interface for remote devices to access applications executing on the computer system hosting the communications interface. The remote devices may be other server systems, personal computers, or other systems. Communication between CITA and the remote devices may use the transmission control protocol/internet protocol (TCP/IP).

The communications interface may register with the operating system on the server as a communications management system (CMS) program for access to an application programming interface (API), such as the TIP environment, and uses message control bank (MCB) for input and output messages to and from the applications executing in the TIP environment.

CITA may attempt to initialize each of the configured MCBs at startup time. A new configuration parameter may specify a retry timer length for re-attempting failed connections. A value for the retry time length may be zero, to indicate no retry, or a number of seconds to wait until retrying the connection to a remote device.

When the communications interface is notified that a connection has failed, the communications interface may start a timer for the application corresponding to the failed connection. When the timer expires, such as when the time specified by the retry timer length is exceeded, and if the application that made the request is still executing, the connection may be retried.

Connections may be identified by position identifier (PID) numbers. The PID numbers may be chosen from a pool of available numbers as each connection is opened, or the PID numbers may be pre-defined by a fixed mapping to remote IP addresses. Where a number of connections exist for an application, a retry timer length may be specified for each connection, or the retry timer length may be specified globally for the application or pool of applications.

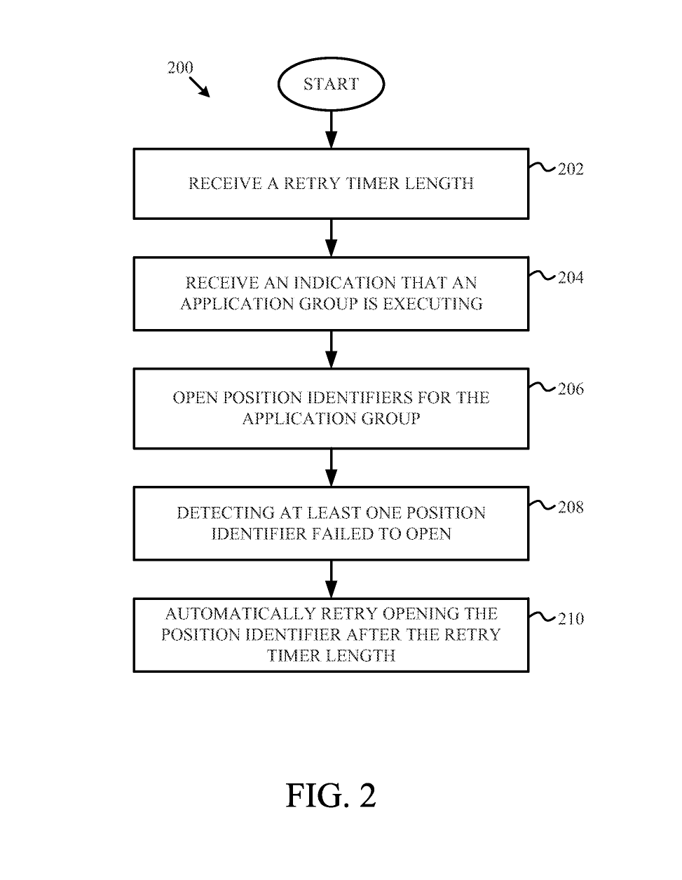

FIG. 2 is a flow chart illustrating an exemplary method of establishing connections through a communications interface to network devices according to one embodiment of the disclosure. A method 200 begins at block 202 with receiving a retry timer length. At block 204, an indication is received that an application group is executing. At block 206, network connections, or position identifiers, are opened for the application group. At block 208, at least one position identifier fails to open. At block 210, opening the position identifier is re-tried after the retry timer length.

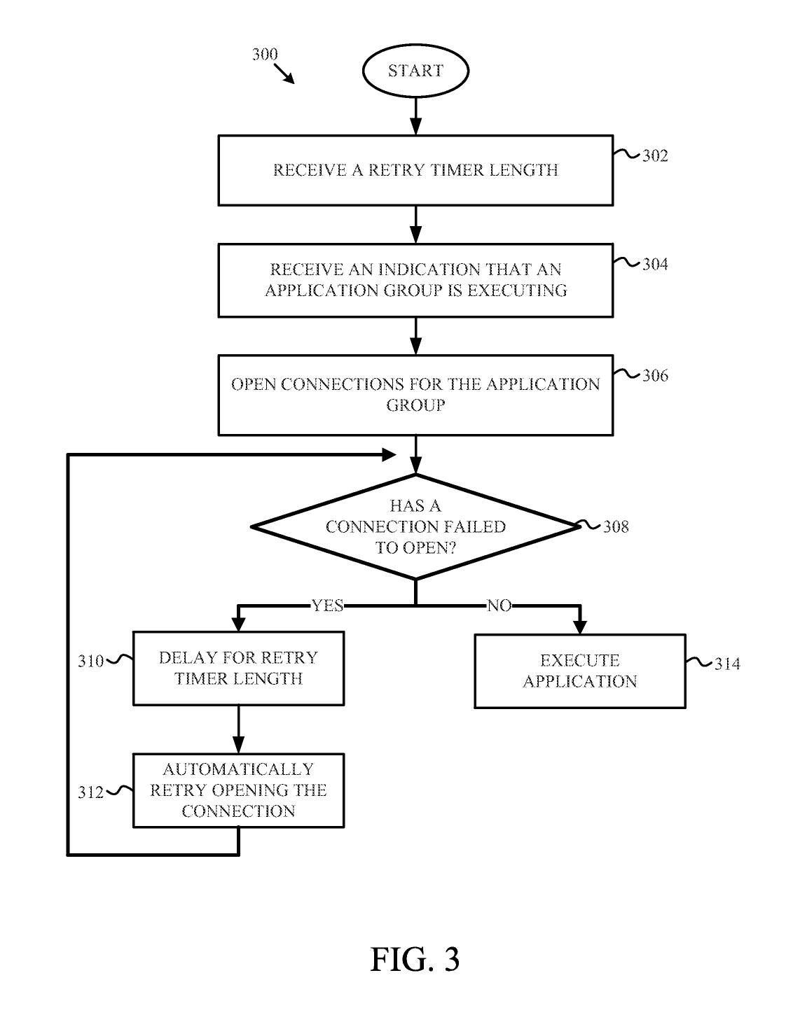

FIG. 3 is a flow chart illustrating an exemplary method of establishing connections by retrying connections according to one embodiment of the disclosure. A method 300 begins at block 302 with receive a retry timer length. At block 304, an indication is received that an application group is executing. At block 306, connections, such as position identifiers, may be opened for the application group. At block 308, it is determined whether a connection has failed to open. If so, then at block 310 a delay equal to the retry timer length is executed. After the delay, an automatic attempt to retry the connection is made at block 312. At block 308, it is again determined whether the connection was opened, and if not then the delay and retry attempt of blocks 310 and 312 may be repeated. When the connection is determined to be successful at block 308, then the application may execute normally at block 314.

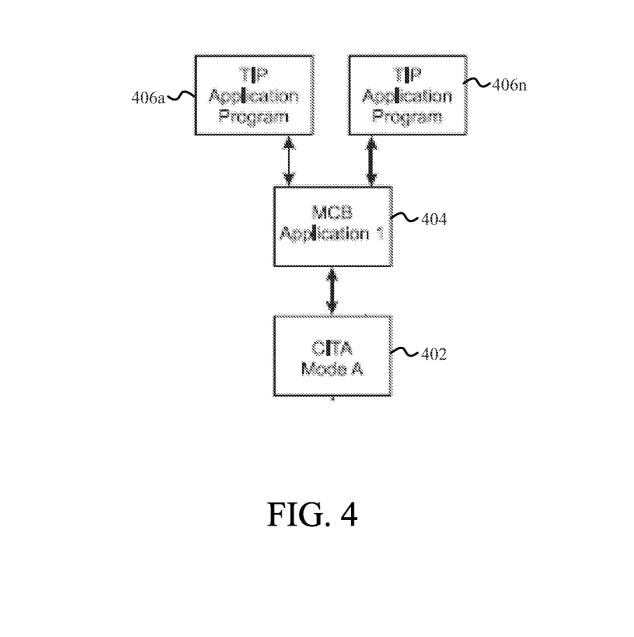

FIG. 4 is a block diagram illustrating a communications interface servicing a number of applications according to one embodiment of the disclosure. A communications interface 402 may communicate with a MCB application 404. The MCB application 404 may communicate with one or more TIP application programs 406a-n. Each of the TIP application programs 406a-n may establish one or more connections identified by PIDs.

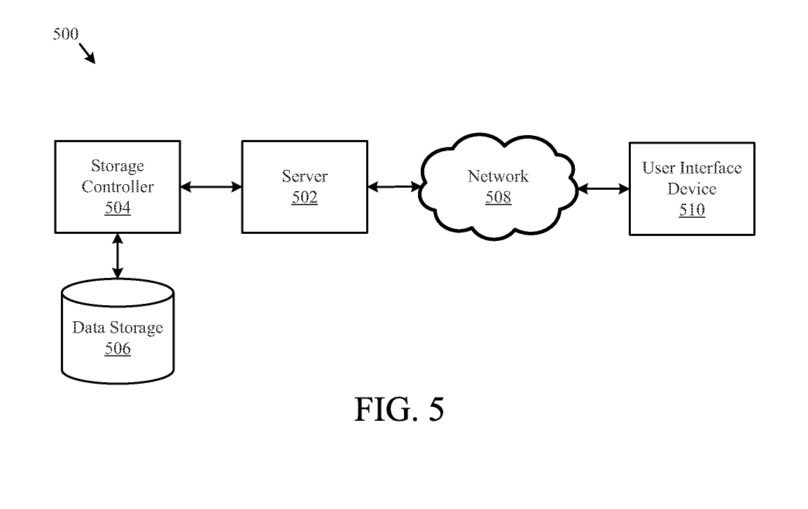

FIG. 5 illustrates one embodiment of a system 500 for an information system, including a system for retrying connections between network devices. The system 500 may include a server 502, a data storage device 506, a network 508, and a user interface device 510. The server 502 may also be a hypervisor-based system executing one or more guest partitions hosting operating systems with modules having server configuration information. In a further embodiment, the system 500 may include a storage controller 504, or a storage server configured to manage data communications between the data storage device 506 and the server 502 or other components in communication with the network 508. In an alternative embodiment, the storage controller 504 may be coupled to the network 508.

In one embodiment, the user interface device 510 is referred to broadly and is intended to encompass a suitable processor-based device such as a desktop computer, a laptop computer, a personal digital assistant (PDA) or tablet computer, a smartphone or other mobile communication device having access to the network 508. When the device 510 is a mobile device, sensors (not shown), such as a camera or accelerometer, may be embedded in the device 510. When the device 510 is a desktop computer the sensors may be embedded in an attachment (not shown) to the device 510. In a further embodiment, the user interface device 510 may access the Internet or other wide area or local area network to access a web application or web service hosted by the server 502 and may provide a user interface for enabling a user to enter or receive information.

The network 508 may facilitate communications of data between the server 502 and the user interface device 510. The network 508 may include any type of communications network including, but not limited to, a direct PC-to-PC connection, a local area network (LAN), a wide area network (WAN), a modem-to-modem connection, the Internet, a combination of the above, or any other communications network now known or later developed within the networking arts which permits two or more computers to communicate.

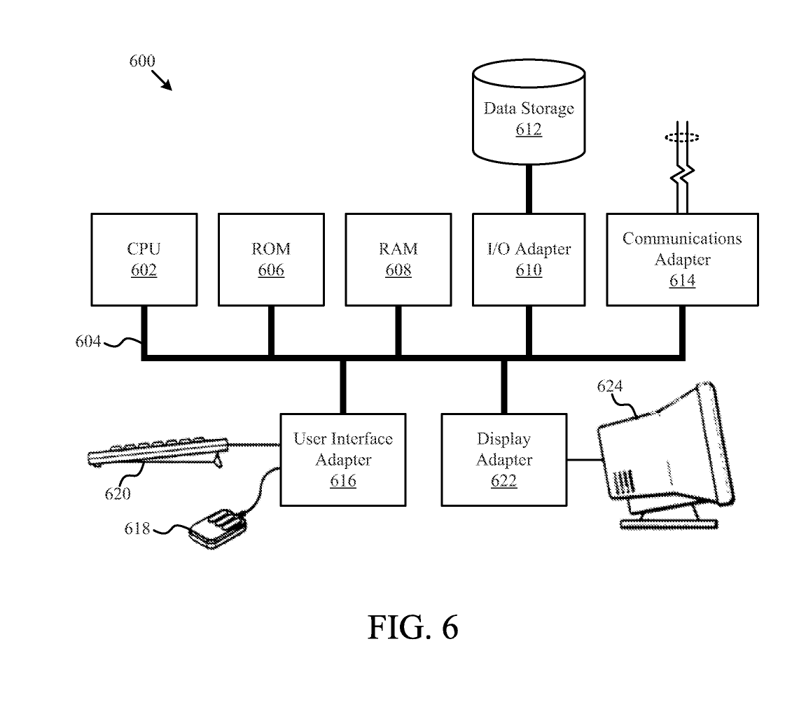

FIG. 6 illustrates a computer system 600 adapted according to certain embodiments of the server 502 and/or the user interface device 510. The central processing unit (“CPU”) 602 is coupled to the system bus 604. The CPU 602 may be a general purpose CPU or microprocessor, graphics processing unit (“GPU”), and/or microcontroller. The present embodiments are not restricted by the architecture of the CPU 602 so long as the CPU 602, whether directly or indirectly, supports the operations as described herein. The CPU 602 may execute the various logical instructions according to the present embodiments.

The computer system 600 also may include random access memory (RAM) 608, which may be synchronous RAM (SRAM), dynamic RAM (DRAM), synchronous dynamic RAM (SDRAM), or the like. The computer system 600 may utilize RAM 608 to store the various data structures used by a software application. The computer system 600 may also include read only memory (ROM) 606 which may be PROM, EPROM, EEPROM, optical storage, or the like. The ROM may store configuration information for booting the computer system 600. The RAM 608 and the ROM 606 hold user and system data, and both the RAM 608 and the ROM 606 may be randomly accessed.

The computer system 600 may also include an input/output (I/O) adapter 610, a communications adapter 614, a user interface adapter 616, and a display adapter 622. The I/O adapter 610 and/or the user interface adapter 616 may, in certain embodiments, enable a user to interact with the computer system 600. In a further embodiment, the display adapter 622 may display a graphical user interface (GUI) associated with a software or web-based application on a display device 624, such as a monitor or touch screen.

The I/O adapter 610 may couple one or more storage devices 612, such as one or more of a hard drive, a solid state storage device, a flash drive, a compact disc (CD) drive, a floppy disk drive, and a tape drive, to the computer system 600. According to one embodiment, the data storage 612 may be a separate server coupled to the computer system 600 through a network connection to the I/O adapter 610. The communications adapter 614 may be adapted to couple the computer system 600 to the network 508, which may be one or more of a LAN, WAN, and/or the Internet. The communications adapter 614 may also be adapted to couple the computer system 600 to other networks such as a global positioning system (GPS) or a Bluetooth network. The user interface adapter 616 couples user input devices, such as a keyboard 620, a pointing device 618, and/or a touch screen (not shown) to the computer system 600. The keyboard 620 may be an on-screen keyboard displayed on a touch panel. Additional devices (not shown) such as a camera, microphone, video camera, accelerometer, compass, and or gyroscope may be coupled to the user interface adapter 616. The display adapter 622 may be driven by the CPU 602 to control the display on the display device 624. Any of the devices 602-622 may be physical and/or logical.

The applications of the present disclosure are not limited to the architecture of computer system 600. Rather the computer system 600 is provided as an example of one type of computing device that may be adapted to perform the functions of the server 502 and/or the user interface device 510. For example, any suitable processor-based device may be utilized including, without limitation, personal data assistants (PDAs), tablet computers, smartphones, computer game consoles, and multi-processor servers. Moreover, the systems and methods of the present disclosure may be implemented on application specific integrated circuits (ASIC), very large scale integrated (VLSI) circuits, or other circuitry. In fact, persons of ordinary skill in the art may utilize any number of suitable structures capable of executing logical operations according to the described embodiments. For example, the computer system 600 may be virtualized for access by multiple users and/or applications.

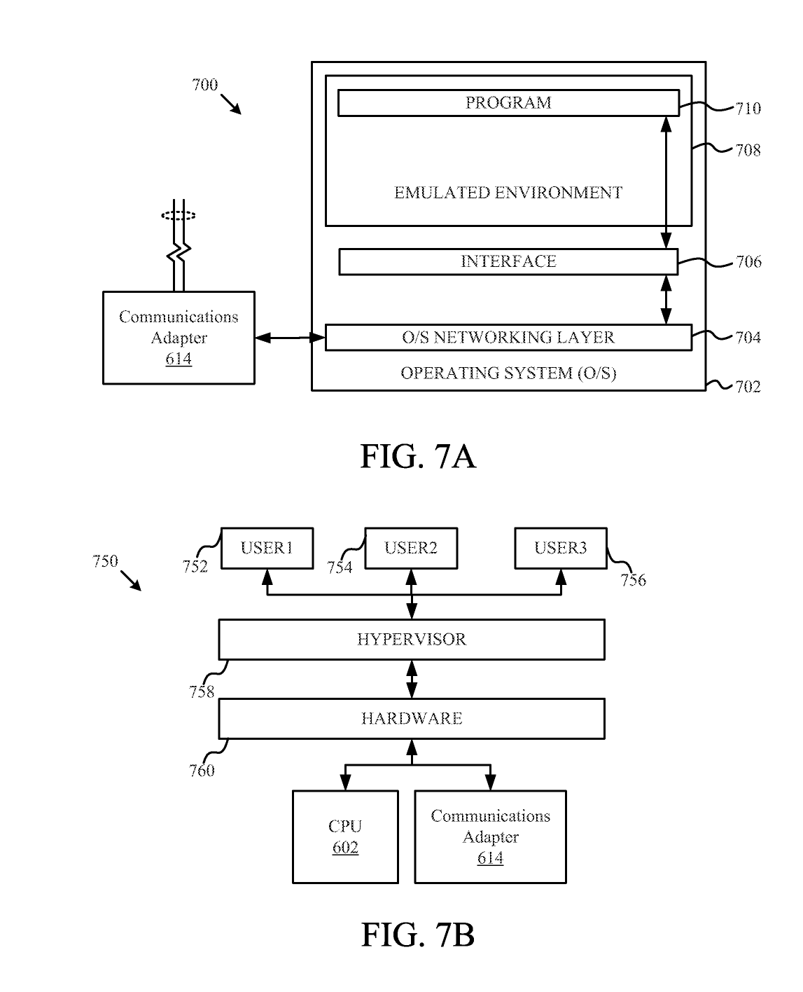

FIG. 7A is a block diagram illustrating a server hosting an emulated software environment for virtualization according to one embodiment of the disclosure. An operating system 702 executing on a server includes drivers for accessing hardware components, such as a networking layer 704 for accessing the communications adapter 714. The operating system 702 may be, for example, Linux. An emulated environment 708 in the operating system 702 executes a program 710, such as CPCommOS. The program 710 accesses the networking layer 704 of the operating system 702 through a non-emulated interface 706, such as XNIOP. The non-emulated interface 706 translates requests from the program 710 executing in the emulated environment 708 for the networking layer 704 of the operating system 702.

In another example, hardware in a computer system may be virtualized through a hypervisor. FIG. 7B is a block diagram illustrating a server hosting an emulated hardware environment according to one embodiment of the disclosure. Users 752, 754, 756 may access the hardware 760 through a hypervisor 758. The hypervisor 758 may be integrated with the hardware 760 to provide virtualization of the hardware 760 without an operating system, such as in the configuration illustrated in FIG. 7A. The hypervisor 758 may provide access to the hardware 760, including the CPU 602 and the communications adaptor 614.

If implemented in firmware and/or software, the functions described above may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Disk and disc includes compact discs (CD), laser discs, optical discs, digital versatile discs (DVD), floppy disks and blu-ray discs. Generally, disks reproduce data magnetically, and discs reproduce data optically. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present invention, disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method, comprising:
receiving a retry timer length;
receiving an indication that an application group is executing;
opening position identifiers for the application group;
failing to open at least one position identifier; and
automatically retrying opening the position identifier after the retry timer length.

2. The method of claim 1, in which the retry timer length is a duration of seconds.

3. The method of claim 1, in which failing to open at least one position identifier comprises receiving at least one of an indication that a peer is unavailable and an indication of a communications error.

4. The method of claim 1, further comprising:
failing to open at least one position identifier after retrying opening the position identifier;
retrying opening the position identifier after the retry timer length; and
repeating retrying opening the position identifier after the retry timer length until the position identifier is opened.

5. The method of claim 1, in which the step of retrying opening the position identifier occurs while the application group is executing.

6. The method of claim 5, in which the step of retrying opening the position identifier occurs without stopping execution of the application group.

7. A computer program product, comprising:
a non-transitory computer readable medium comprising
code to receive a retry timer length;
code to receive an indication that an application group is executing;
code to open position identifiers for the application group; and
code to retrying opening a failed position identifier after the retry timer length when at least one position identifier fails to open.

8. The computer program of claim 8, in which the retry timer length is a duration of seconds.

9. The computer program of claim 8, in which the medium further comprises code to receive at least one of an indication that a peer is unavailable and an indication of a communications error.

10. The computer program of claim 8, in which the medium further comprises:
code to retry opening the position identifier after the retry timer length after retrying opening the position identifier; and
code to repeat retrying opening the position identifier after the retry timer length until the position identifier is opened.

11. The computer program of claim 8, in which the medium further comprises code to retry opening the position identifier without stopping execution of the application group.

12. An apparatus, comprising:
a memory;
a network adapter; and
a processor coupled to the memory and coupled to the network adapter, in which the processor is configured:
to receive a retry timer length;
to receive an indication that an application group is executing;
to open, through the network adapter, position identifiers for the application group; and
to retrying opening a failed position identifier after the retry timer length when at least one position identifier fails to open.

13. The apparatus of claim 12, in which the retry timer length is a duration of seconds stored in the memory.

14. The apparatus of claim 12, in which the processor is further configured to receive at least one of an indication that a peer is unavailable and an indication of a communications error.

15. The apparatus of claim 12, in which the processor is further configured:
to retry opening the position identifier after the retry timer length after retrying opening the position identifier; and
to repeat retrying opening the position identifier after the retry timer length until the position identifier is opened.

16. The apparatus of claim 12, in which the processor is further configured to retry opening the position identifier without stopping execution of the application group.
